(19) United States
(12) Patent Application Publication
(10) Pub. No.: US 2020/0063771 A1
(43) Pub. Date: Feb. 27, 2020

(54) VANE LOCKING APPARATUS

(71) Applicant: DURO DYNE CORPORATION, Bay Shore, NY (US)

(72) Inventors: Andrew J. BELLISE, Farmingdale, NY (US); David B. KRUPNICK, Mattituck, NY (US); Ainsley F. SMITH, Springfield Gardens, NY (US)

(73) Assignee: DURO DYNE CORPORATION, Bay Shore, NY (US)

(21) Appl. No.: 16/500,594

(22) PCT Filed: Apr. 4, 2018
(86) PCT No.: PCT/US2018/026012

§ 371 Date: Oct. 3, 2019

Related U.S. Application Data
(60) Provisional application No. 62/481,806, filed on Apr. 5, 2017.

(51) Int. Cl. F16B 5/00

(52) U.S. Cl. CPC F16B 5/0096; F15D 1/04

(57) ABSTRACT

A locking apparatus for securing a turning vane to a duct rail is disclosed. The locking apparatus includes an elongate body defining a longitudinal axis and a working end including a first end portion, a second end portion, and an arcuate portion extending between the first end portion and the second end portion. The first end portion, second end portion, and arcuate portion together define a concavity that is configured for the reception of a portion of the turning vane therein. The arcuate portion is configured for engagement against the portion of the turning vane to roll the portion of the turning vane over a portion of the duct rail. The rolling of the portion of the turning vane over the portion of the duct rail is configured to secure the turning vane to the duct rail.

### FIELD

The present disclosure relates to apparatus and methods for attaching hollow turning vanes to rail assemblies for use in a heating, ventilation, and air conditioning (HVAC) systems.

### BACKGROUND

Hollow turning vane and rail assemblies are used in the ductwork of HVAC systems to smoothly direct airflow when there is a change of direction, for example, around an intersection or corner in the ductwork. Assembling hollow turning vanes to rails may be difficult and time consuming in the HVAC industry. During assembly, hollow turning vanes are often secured to the rails using a friction fit. However, the friction fit may be unstable during the assembly process. In other methods, hand held hollow turning vane dimplier tools may be used to form a locking dimple on the vane by manually squeezing and releasing the tool on the hollow turning vane either before or after the vane is seated on the rail. Hand held chisels are often used with a hammer to deform and cut the hollow turning vane after the vane is friction fit to the rail forming an inconsistent and time consuming assembly.

### BRIEF SUMMARY

In an aspect, a system, apparatus, and method described herein secures a hollow turning vane to a duct rail, for example, by applying a medium barrel air hammer to a locking apparatus. The locking apparatus powered by the air hammer quickly and securely locks the hollow turning vane to the duct rail by rolling a portion of the hollow turning vane over a portion of the duct, cutting a rolled notched lock to create a secure assembly of the two mating parts.

In an aspect of the present disclosure, a locking apparatus for securing a turning vane to a duct rail is disclosed. The locking apparatus includes an elongate body defining a longitudinal axis and a working end including a first end portion, a second end portion, and an arcuate portion extending between the first end portion and the second end portion. The first end portion, second end portion, and arcuate portion together define a concavity that is configured for the reception of a portion of the turning vane therein. The arcuate portion is configured for engagement against the portion of the turning vane to roll the portion of the turning vane over a portion of the duct rail. The rolling of the portion of the turning vane over the portion of the duct rail is configured to secure the turning vane to the duct rail.

In another aspect, the first end portion extends from the working end farther than the second end portion.

In some aspects, the engagement of the arcuate portion against the portion of the turning vane rolls the portion of the turning vane along the arcuate portion in the direction of the first end portion.

In an aspect of the present disclosure, a method for securing a turning vane to a duct rail is disclosed. The method includes inserting a mounting portion of a duct rail into a cavity of a turning vane, positioning a working end of a locking apparatus against a portion of the turning vane, and driving the working end of the locking apparatus against the portion of the turning vane to roll the portion of the turning vane over a portion of the duct rail, the rolling of the portion of the turning vane over the portion of the duct rail securing the turning vane to the duct rail.

In some aspects, positioning the working end of the locking apparatus against the portion of the turning vane includes positioning an arcuate portion that extends between a first end portion and a second end portion of the working end against the portion of the turning vane.

In another aspect, driving the working end of the locking apparatus against the portion of the turning vane to roll the portion of the turning vane comprises driving the arcuate portion of the locking apparatus against the portion of the turning vane to roll the portion of the turning vane in the direction of the first end portion.

In some aspects, the first end portion extends farther from the working end of the locking apparatus than the second end portion.

Any of the above aspects may be combined in any manner without departing from the scope of the present disclosure.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 illustrates images of a hollow vane locking system in accordance with an aspect of the present disclosure.

FIG. 2 is a front view of a locking apparatus of the system of FIG. 1.

FIG. 3 is a left side view of the locking apparatus of FIG. 2.

FIG. 4 is an image of a working end of the locking apparatus of FIG. 2.

FIG. 5 is an image of a duct rail and hollow turning vane in accordance with an aspect of the present disclosure.

FIG. 6 is another image of the duct rail and hollow turning vane of FIG. 5, taken from a different angle.

FIG. 7 is an image of the duct rail and hollow turning vane of FIG. 5 with the locking apparatus of FIG. 2 positioned adjacent an edge of the hollow turning vane.

FIG. 8 is an image of the duct rail and hollow turning vane of FIG. 5 with the locking apparatus of FIG. 2 engaged against the edge of the hollow turning vane.

FIG. 9 is an image of the duct rail and hollow turning vane of FIG. 5 with the locking apparatus of FIG. 2 rolling a portion of the edge of the hollow turning vane over a portion of the duct rail.

FIG. 10 is an image of the duct rail and hollow turning vane of FIG. 5 showing the hollow turning vane secured to the duct rail by the rolled portion of the edge of the hollow turning vane over the portion of the duct rail.

### DETAILED DESCRIPTION

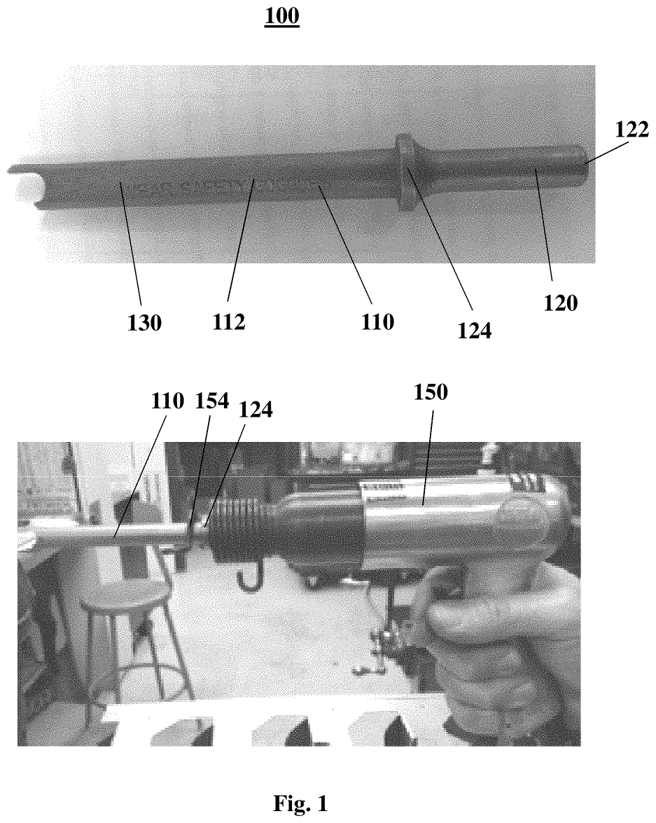

With reference now to FIG. 1, a hollow vane locking system 100 is illustrated including a locking apparatus 110 and a pneumatic air hammer 150.

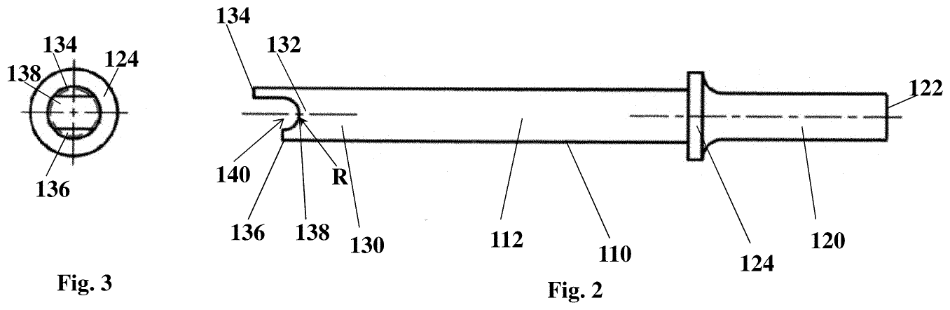

With reference to FIGS. 2 and 3, locking apparatus 110 includes an elongate body 112 having a proximal portion 120 and a distal portion 130. In an aspect, body 112 extends in a longitudinal direction along an axis 114. In some aspects, body 112 may define a circular cross-section as illustrated, for example, in FIG. 3. In some aspects body 112 may define any other cross-sectional shape without departing from the scope of the present disclosure including, for example, a rectangular cross-section, square cross-section, triangular cross-section, hexagonal cross-section, or any other cross-sectional shape.

Proximal portion 120 includes a proximal end 122 and a flange or lip 124. Proximal portion 120 is configured for removable attachment to pneumatic air hammer 150. For example, proximal portion 120 may be inserted into an opening (not shown) of pneumatic air hammer 150 and secured to pneumatic air hammer 150, e.g., using friction fit, snap fit, or any other manner of removable attachment. In some aspects, for example, a tensioning member 154 of pneumatic air hammer 150 may be used to removably secure locking apparatus 110 to pneumatic air hammer 150. For example, tensioning member 154, e.g., a spring, coil, or other tensioning member, may be engaged with the flange or lip 124 to removably secure locking member 110 within the opening 152 of pneumatic air hammer 150.

In some aspects, pneumatic air hammer 150 may include any medium barrel air hammer. In some aspects, for example, pneumatic air hammer 150 may be any type or size of air hammer or any other apparatus that is configured to drive locking apparatus 110 distally using air pressure or any other form of pressure or method of driving locking apparatus 110 distally, mechanical or otherwise. In some aspects, for example, pneumatic air hammer 150 may be configured to apply pressure at 70 PSI to locking apparatus 110.

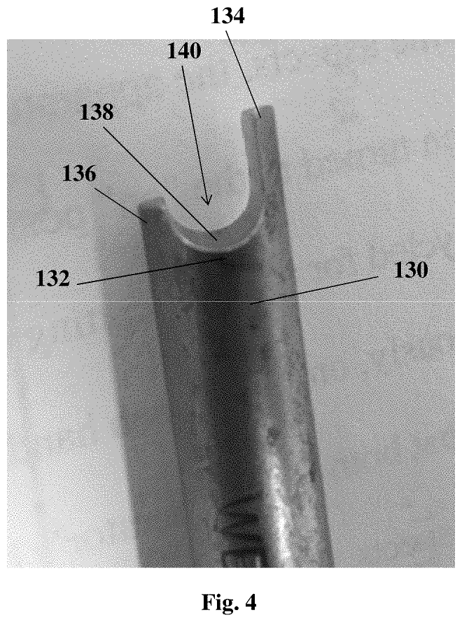

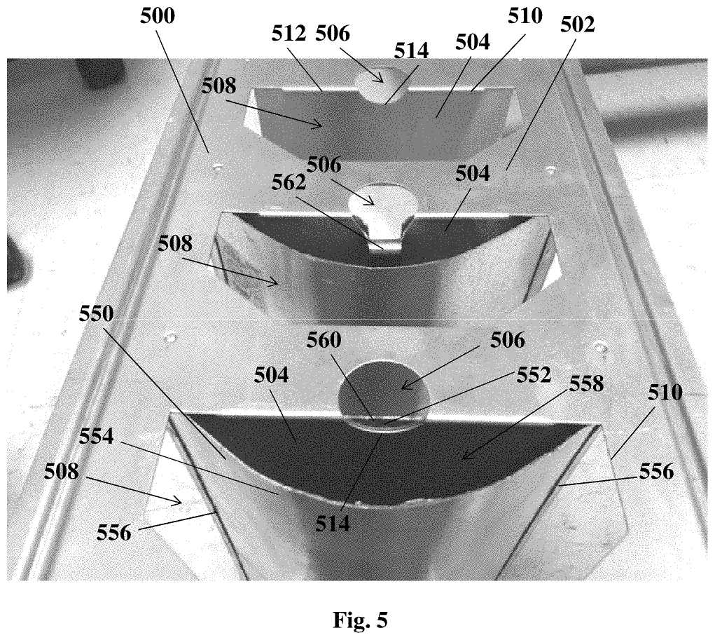

With reference now to FIGS. 2-4, distal portion 130 includes a working end 132 that is configured for engagement against a duct rail 500 (FIG. 5) or a hollow turning vane 550 (FIG. 5) to secure the hollow turning vane 550 to the duct rail 500.

Working end 132 includes a first end portion 134 extending distally from working end 132 and a second end portion 136 extending distally from working end 132. In some aspects, first end portion 134 and second end portion 136 may be disposed on opposite sides of axis 114. In some aspects, first end portion 134 may extend distally from working end 132 farther than second end portion 136. For example, in some aspects, first end portion 134 may extend from working end 132 twice as far or more than second end portion 136. In some aspects, for example, first end portion 134 may extend from working end 132 about a quarter inch farther than second end portion 136.

An arcuate portion 138 extends between first and second end portions 134 and 136 defining a concavity 140 between first and second end portions 134 and 136 for receiving a portion of hollow turning vane 400 or duct rail 500. In some aspects, for example, arcuate portion 138 may define a radius R, for example, a radius R of about 7/64 of an inch to about 11/64 of an inch, and in some aspects, a radius R of about 9/64 of an inch. In some aspects, for example, radius R may be about 9/64+− 1/64 of an inch.

In some aspects, locking apparatus 110 may be formed, for example, from A2 steel. For example, A2 steel may provide good machineability, high stability after hardening, and a wear resistance that is both economical and durable for use in the field. In some aspects, any other manner of formation may also be contemplated including, for example, water hardening, cold work, e.g., oil-hardening, air-hardening, or other similar formation techniques. In some aspects, locking apparatus 110 may be hardened to RC 62-64 on the Rockwell hardness scale.

In some aspects, locking apparatus 110 may be coated with an electro plate finish that may reduce wear and tear on the first and second end portions 134 and 136, working end 132, or any other surfaces of locking apparatus 110 during use. In some aspects, the finish may be black or any other color.

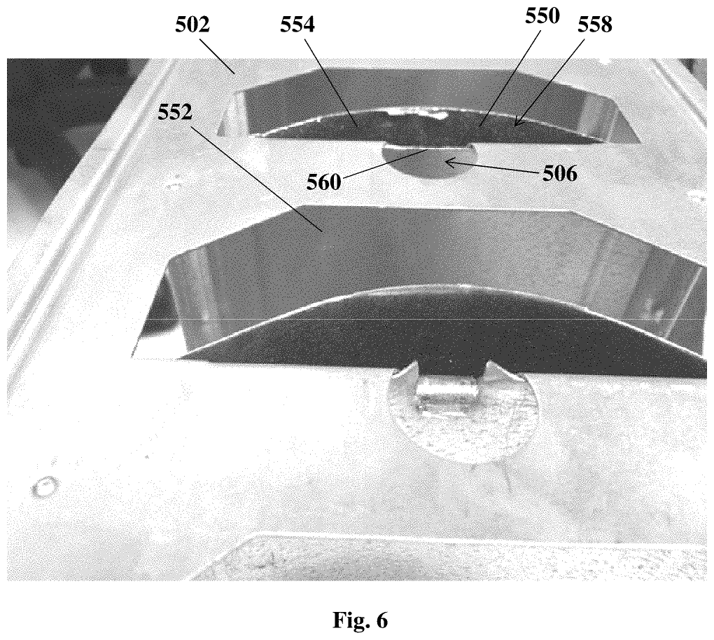

With reference now to FIGS. 5 and 6, duct rail 500 includes a body 502, at least one mounting portion 504 disposed at an angle to body 502, and openings 506 each extending through body 502 and one of the mounting portions 504.

In some aspects, each mounting portion 504 may be formed by a cut-out 508 of body 502. For example, each mounting portion 504 may initially be formed as part of body 502 with an opening 506 extending through body 502 and the mounting portion 504. A perimeter 510 of the mounting portion 504 may then be cut from body 502 leaving portions 512 and 514 uncut. For example, portions 512 and 514 may be adjacent the opening 506 extending through that mounting portion 504. Mounting portion 504 may be bent along portions 512 and 514 such that mounting portion 504 is angled relative to body 502 with the opening 506 extending through both body 502 and mounting portion 504. In some aspects, mounting portion 504 may be bent to a right angle, i.e., ninety degree angle relative to body 502. In some aspects, mounting portion 504 may be bent to any other angle relative to body 502 for use in securing hollow turning vane 550 to duct rail 500.

With continued reference to FIGS. 5 and 6, each hollow turning vane 550 includes a backing 552 and an arcuate portion 554. In some aspects, arcuate portion 554 may be secured to backing 552 at peripheral edges 556 to define a cavity 558 between arcuate portion 554 and backing 552. Cavity 558 is configured to receive one of mounting portions 504 of duct rail 500 such that an edge 560 of backing 552 is positioned adjacent to or abutting opening 506 of duct rail 500. For example, when hollow turning vane 550 is positioned for securement to duct rail 500, cavity 558 may receive one of mounting portions 504 such that edge 560 of backing 552 abuts or is adjacent to body 102 and opening 506. Locking apparatus 110 may then be engaged against edge 560 to secure hollow turning vane 550 to duct rail 500 by rolling a portion 562 of edge 560 against a side edge 514 of opening 506 to inhibit removal of hollow turning vane 550 from duct rail 500. In some aspects, for example, rolled portion 562 of edge 560 against side edge 514 of opening 506 may also cause side edge 514 of opening 506 to be rolled. Once portion 562 of edge 560 has been rolled against the side edge 514 of opening 506, removal of hollow turning vane 550 from abutment against or adjacency with body 112 may be inhibited by engagement of portion 562 of edge 560 against side edge 514 of opening 506.

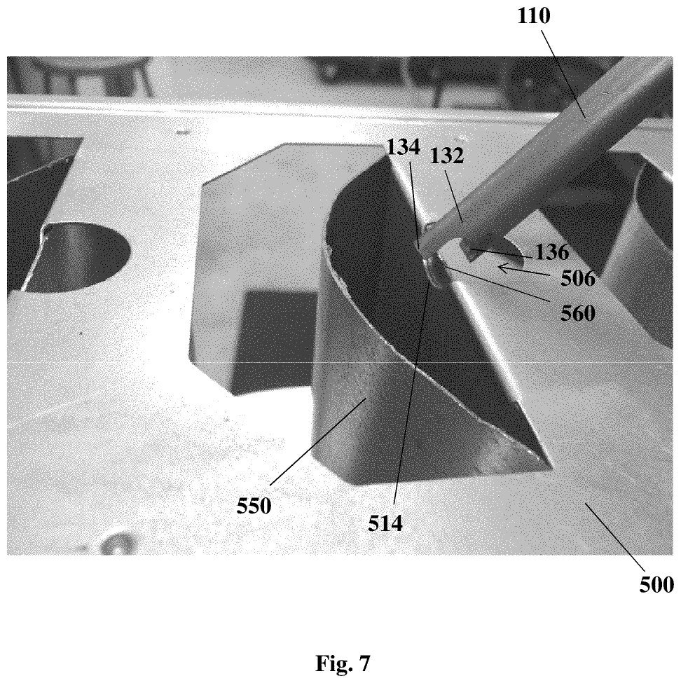

With reference now to FIGS. 7-10 the rolling of portion 562 of edge 560 against side edge 514 of opening 506 using locking apparatus 110 will now be described.

Referring initially to FIG. 7, hollow turning vane 550 is positioned against body 502 of duct rail 500 such that mounting portion 504 of duct rail 500 is received within cavity 558 of hollow turning vane 550 with edge 560 of hollow turning vane 550 positioned adjacent to or abutting body 502 and opening 506. As can be seen in FIG. 7, edge 560 may be positioned adjacent the portion of opening 506 extending through mounting portion 504 such that side edge 514 of opening 506 is disposed farther from the plane of body 502 than edge 560.

With further reference to FIG. 7, locking apparatus 110 may be attached to pneumatic air hammer 150 and initially positioned such that working end 132 is adjacent to edge 560. In some aspects, for example, locking apparatus 110 may be positioned such that edge 560 of hollow turning vane 550 is disposed within concavity 140 with first and second end portions 134 and 136 positioned on either side of edge 560.

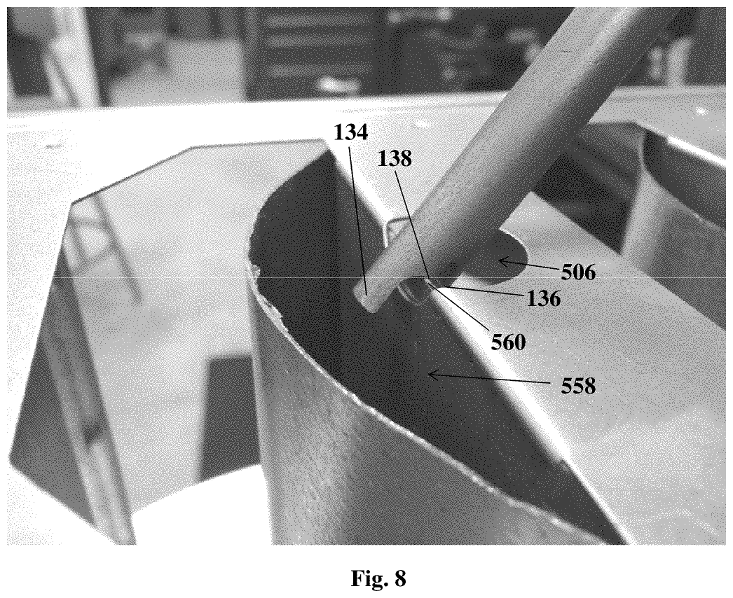

With reference to FIG. 8, locking apparatus 110 is moved distally towards edge 560 until arcuate portion 138 abuts against edge 560 of hollow turning vane 550 with second end portion 136 of locking apparatus 110 extending into opening 506 of duct rail 500 and first end portion 134 of locking apparatus 110 extending into cavity 558 of hollow turning vane 550.

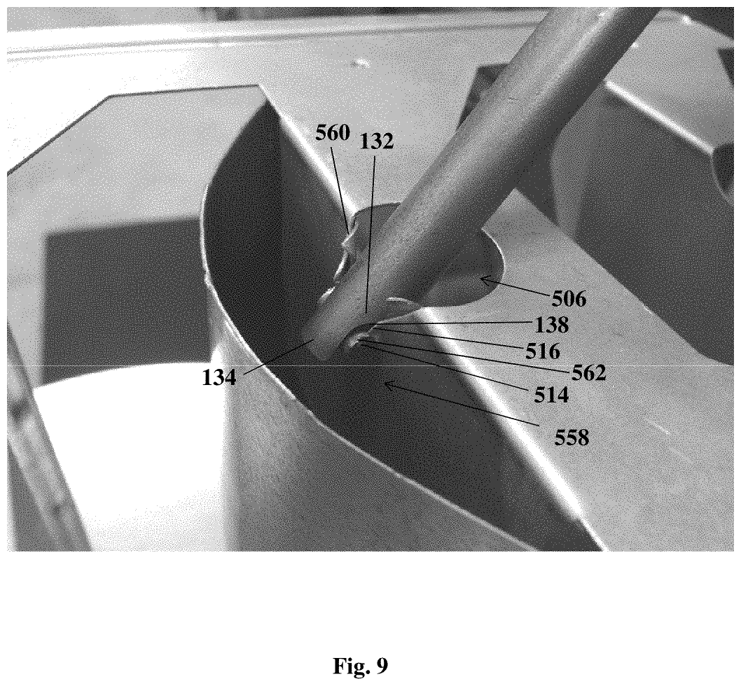

With reference now to FIG. 9, pneumatic air hammer 150 is activated to drive locking apparatus 110 distally toward edge 560 of hollow turning vane 550. As locking apparatus 110 is driven distally against edge 560, edge 560 deforms against arcuate portion 138 to form a rolled portion 562 that extends towards first end portion 134. During formation, rolled portion 562 is also cut from edge 560 by locking apparatus 110.

As rolled portion 562 is formed, rolled portion 562 also engages against side edge 514 of opening 506. In some aspects, as rolled portion 562 engages against side edge 514, side edge 514 is cut from the sides 516 of opening 506 and rolled towards first end portion 134 of locking apparatus 110 in a similar manner to rolled portion 562. In some aspects, rolled portion 526 may alternatively engage against side edge 514 without rolling or cutting side edge 514.

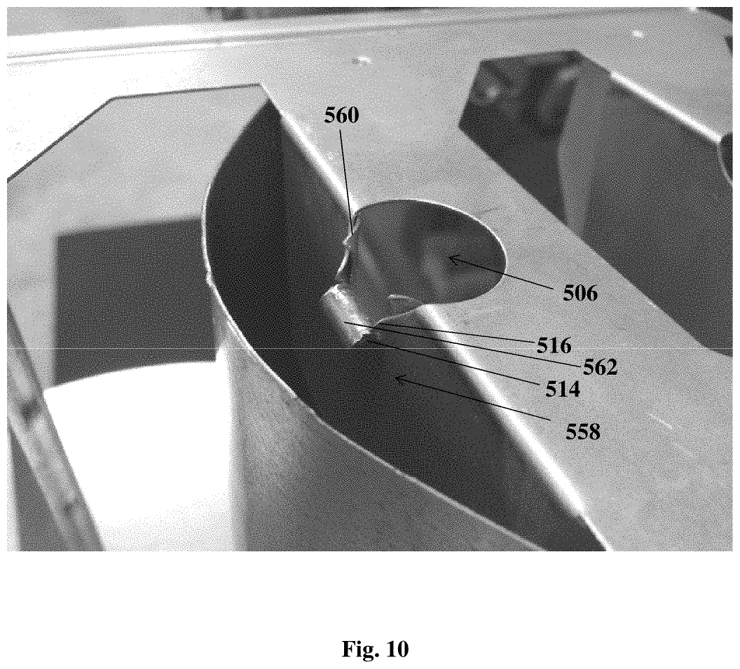

With reference now to FIG. 10, after rolling of rolled portion 562 is complete, locking apparatus 110 may be removed. As can be seen in FIG. 10, hollow turning vane 550 is secured to duct rail 500 by the engagement of rolled portion 562 of the backing 552 of hollow turning vane 550 against side edge 514 of the opening 506 of duct rail 500 and in some aspects by the rolling of side edge 514 with rolled portion 562. The engagement of rolled portion 562 of hollow turning vane 550 against side edge 514 of opening 506 of duct rail 500, and in some aspects rolling of side edge 514, forms a rolled notched lock creating a secured assembly of duct rail 500 and hollow turning vane 550. Hollow turning vane 110 is inhibited from removal from engagement with duct rail 500 due to rolled portion 562 engaging against side edge 114. For example, if hollow turning vane 550 is pulled in a direction away from body 502 of duct rail 500, the engagement of rolled portion 562 against side edge 114 will inhibit movement of hollow turning vane 550 in that direction.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A locking apparatus for securing a turning vane to a duct rail, the locking apparatus comprising:
an elongate body defining a longitudinal axis and a working end comprising a first end portion, a second end portion, and an arcuate portion extending between the first end portion and the second end portion, the first end portion, second end portion, and the arcuate portion together defining a concavity that is configured for the reception of a portion of the turning vane therein, the arcuate portion configured for engagement against the portion of the turning vane to roll the portion of the turning vane over a portion of the duct rail, the rolling of the portion of the turning vane over the portion of the duct rail configured to secure the turning vane to the duct rail.

2. The locking apparatus of claim 1, wherein the first end portion extends from the working end farther than the second end portion.

3. The locking apparatus of claim 2, wherein the engagement of the arcuate portion against the portion of the turning vane rolls the portion of the turning vane along the arcuate portion in the direction of the first end portion.

4. A method for securing a turning vane to a duct rail, the method comprising:
inserting a mounting portion of a duct rail into a cavity of a turning vane;
positioning a working end of a locking apparatus against a portion of the turning vane; and
driving the working end of the locking apparatus against the portion of the turning vane to roll the portion of the turning vane over a portion of the duct rail, the rolling of the portion of the turning vane over the portion of the duct rail securing the turning vane to the duct rail.

5. The method of claim 4, wherein positioning the working end of the locking apparatus against the portion of the turning vane comprises:
positioning an arcuate portion that extends between a first end portion and a second end portion of the working end against the portion of the turning vane.

6. The method of claim 5, wherein driving the working end of the locking apparatus against the portion of the turning vane to roll the portion of the turning vane comprises driving the arcuate portion of the locking apparatus against the portion of the turning vane to roll the portion of the turning vane in the direction of the first end portion.

7. The method of claim 5, wherein the first end portion extends farther from the working end of the locking apparatus than the second end portion.
